(19) United States
(12) Patent Application Publication
(10) Pub. No.: US 2026/0134426 A1
(43) Pub. Date: May 14, 2026

(54) SYSTEMS AND METHODS FOR TRANSACTION PRE-AUTHENTICATION

(71) Applicant: Mastercard International Incorporated, Purchase, NY (US)

(72) Inventors: David Vorhies, Saint Charles, MO (US); Kaushal Shetty, O'Fallon, MO (US)

(73) Assignee: Mastercard International Incorporated, Purchase, NY (US)

(21) Appl. No.: 18/947,214

(22) Filed: Nov. 14, 2024

(51) Int. Cl. G06Q 20/40

(52) U.S. Cl. CPC G06Q 20/401

(57) ABSTRACT

A method includes receiving a digitally signed pre-authentication request from a cardholder device and validating the digitally signed request. The method includes receiving pre-authentication data from the cardholder device. The pre-authentication data is associated with a pre-authenticated transaction. The method includes receiving authentication success information indicating authentication of the cardholder, generating an accountholder authentication value (AAV) for the pre-authenticated transaction, and transmitting the AAV to the issuer. In addition, the operations include receiving a transaction authentication request message including cardholder transaction data from a merchant device. The authentication request message is associated with the pre-authenticated transaction. The transaction details are extracted from the received cardholder transaction data and matched to the received pre-authentication data. Based on the matching, a modified transaction authentication request message is generated by appending the AAV to the transaction authentication request message. The modified transaction authentication request message is transmitted to the issuer.

### BACKGROUND

The field of the disclosure relates generally to electronic financial transactions and, more particularly, to systems and methods for pre-authenticating electronic financial transactions.

Authentication systems, particularly in the Fast Identity Online (FIDO) space, often require repeated user challenges for each transaction, leading to potential security vulnerabilities. The existing Fast Identity Online (FIDO) landscape faces challenges in providing a seamless and secure authentication process. Users are required to undergo authentication challenges for every transaction, leading to inefficiencies and potential security vulnerabilities.

Checkout processes needing a 3DS checkout force additional steps and, at times, out of band interaction to complete a transaction. This can be both slow and clumsy for the user and lead to security problems. In situations like concert tickets or other time-limited purchases, this creates extra friction and stress, and may result in lost transactions. Pre-authenticating a transaction, rather than simply pre-authorizing the transaction, allows the issuer to immediately authorize the transaction upon merchant request, with no delay to the end user or security concerns.

### BRIEF DESCRIPTION

This brief description is provided to introduce a selection of concepts in a simplified form that are further described in the detailed description below. This brief description is not intended to identify key features or essential features of the claimed subject matter, nor is it intended to be used to limit the scope of the claimed subject matter. Other aspects and advantages of the present disclosure will be apparent from the following detailed description of the embodiments and the accompanying figures.

In one aspect, a computer-implemented method is provided. The method includes receiving a digitally signed pre-authentication request from a cardholder device and validating the digitally signed pre-authentication request. The method includes receiving pre-authentication data from the cardholder device. The pre-authentication data is associated with a pre-authenticated transaction. The method also includes receiving, from an issuer associated with the cardholder device, authentication success information indicating authentication of the cardholder. In addition, the method includes generating an accountholder authentication value (AAV) for the pre-authenticated transaction and transmitting the AAV to the issuer. Furthermore, the method includes receiving a transaction authentication request message including cardholder transaction data from a merchant device. The transaction authentication request message is associated with the pre-authenticated transaction. Moreover, the method includes extracting transaction details from the received cardholder transaction data and matching the extracted transaction details to the received pre-authentication data. Based on the matching, a modified transaction authentication request message is generated by appending the AAV to the transaction authentication request message. The modified transaction authentication request message is transmitted to the issuer.

In another aspect, a system is provided. The system includes one or more processors and a memory. The memory stores computer-executable instructions. The computer-executable instructions, when executed by the one or more processors, cause the one or more processors to perform the operations of receiving a digitally signed pre-authentication request from a cardholder device and validating the digitally signed pre-authentication request. The one or more processors also receive pre-authentication data from the cardholder device. The pre-authentication data is associated with a pre-authenticated transaction. The one or more processors receive, from an issuer associated with the cardholder device, authentication success information indicating authentication of the cardholder; generate an accountholder authentication value (AAV) for the pre-authenticated transaction; and transmit the AAV to the issuer. Furthermore, the one or more processors receive a transaction authentication request message including cardholder transaction data from a merchant device. The transaction authentication request message is associated with the pre-authenticated transaction. In addition, the one or more processors extract transaction details from the received cardholder transaction data match the extracted transaction details to the received pre-authentication data, and based on the matching, generate a modified transaction authentication request message by appending the AAV to the transaction authentication request message. Moreover, the one or more processors transmit the modified transaction authentication request message to the issuer.

A variety of additional aspects will be set forth in the detailed description that follows. These aspects can relate to individual features and to combinations of features. Advantages of these and other aspects will become more apparent to those skilled in the art from the following description of the exemplary embodiments which have been shown and described by way of illustration. As will be realized, the present aspects described herein may be capable of other and different aspects, and their details are capable of modification in various respects. Accordingly, the figures and description are to be regarded as illustrative in nature and not as restrictive.

### BRIEF DESCRIPTION OF THE DRAWINGS

The figures described below depict various aspects of systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a block diagram of a pre-authentication system including a transaction pre-authentication service system, in accordance with one embodiment of the present disclosure;

FIG. 2 is a simplified block diagram of an exemplary payment card network system including the transaction pre-authentication service system of FIG. 1;

FIG. 3 is an example configuration of a user system for use with the payment card network system shown in FIG. 2;

FIG. 4 is an example configuration of a server system for use in the payment card network system shown in FIG. 2;

FIG. 5 is a flowchart illustrating an exemplary computer-implemented method for registering a cardholder for a transaction pre-authentication service using the transaction pre-authentication service server shown in FIG. 1; and

FIG. 6 is a flowchart illustrating a computer-implemented method for pre-authenticating a transaction using the transaction pre-authentication service server shown in FIG. 1.

Unless otherwise indicated, the figures provided herein are meant to illustrate features of embodiments of this disclosure. These features are believed to be applicable in a wide variety of systems comprising one or more embodiments of this disclosure. As such, the figures are not meant to include all conventional features known by those of ordinary skill in the art to be required for the practice of the embodiments disclosed herein.

### DETAILED DESCRIPTION

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized, and changes may be made without departing from the scope of the claims. The following description is, therefore, not limiting. The scope of the present invention is defined only by the appended claims, along with the full scope of equivalents to which such claims are entitled.

### EXAMPLE SYSTEM

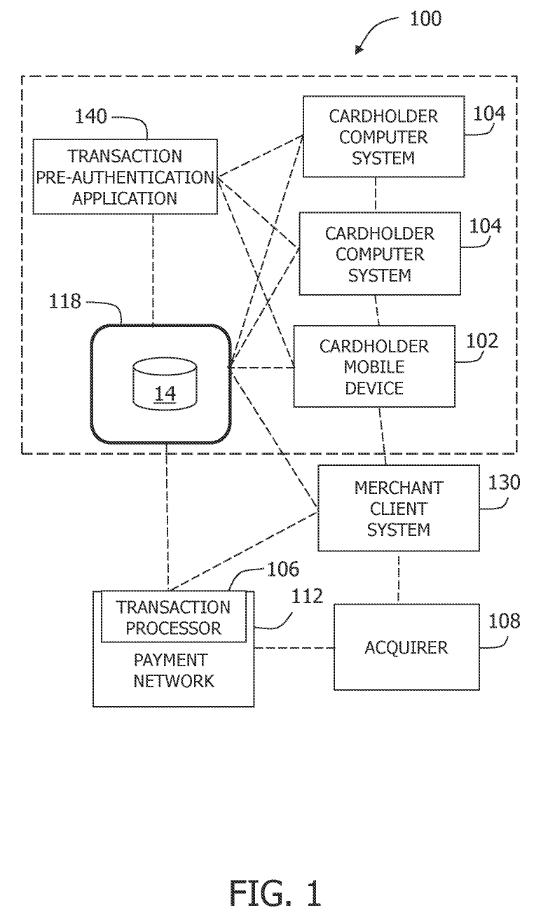

FIG. 1 is a block diagram of a pre-authentication system 100 including a transaction pre-authentication service system 118. The transaction pre-authentication service system 118 includes at least one processor (not shown) in communication with a database 14. The database 14 stores information on a variety of matters, including, for example, stored transaction pre-authentication data for one or more users, one or more user profiles, and other information described herein. In one embodiment, the database 14 is stored on the transaction pre-authentication service system 118. In an alternative embodiment, the database 14 is stored remotely from the transaction pre-authentication service system 118 and may be non-centralized. In the example embodiment, the pre-authentication system 100 is in communication with a transaction processor 106, which is integral to and/or associated with a payment or payment network 112.

In the example embodiment, the pre-authentication system 100 further includes a plurality of client systems or subsystems 130, cardholder mobile devices 102, and/or cardholder computer systems 104. In one embodiment, the cardholder mobile devices 102 and cardholder computer systems 104 are computers including a web browser or application, such that the transaction pre-authentication service system 118 is accessible to the cardholder mobile devices 102 and the cardholder computer systems 104 using the Internet. The cardholder mobile devices 102 and the cardholder computer systems 104 are interconnected to the Internet through many interfaces including a network, such as a local area network (LAN) and/or a wide area network (WAN), dial-in connections, cable modems, wireless-connections, and special high-speed ISDN lines. The cardholder mobile devices 102 and the cardholder computer systems 104 may be any device capable of interconnecting to the Internet including mobile computing devices, such as a laptop or desktop computer, a web-based phone (e.g., a “smart phone”), a personal digital assistant (PDA), a tablet or phablet, a web-connectable appliance, a “smart watch” or other wearable device, or other web-connectable equipment. It should be understood that the pre-authentication system 100 may include any number of cardholder computer systems 104 and cardholder mobile devices 102.

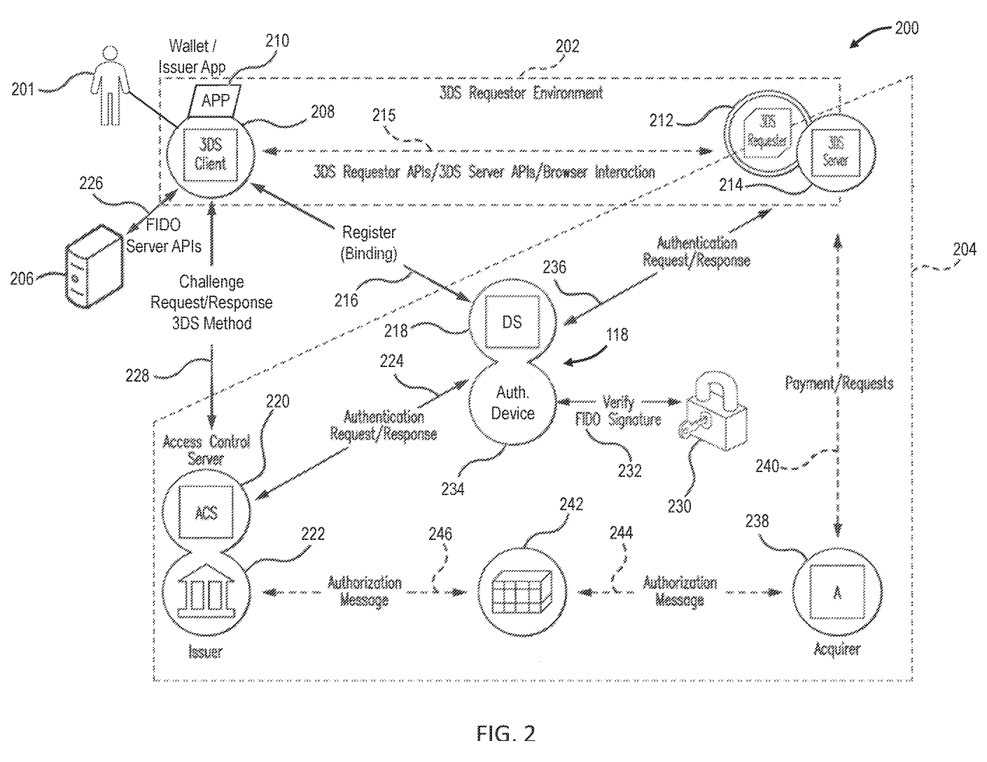

Transaction pre-authentication service system 118 is configured to communicate with a cardholder mobile device 102 and/or a cardholder computer system 104 associated with a cardholder 201 (shown in FIG. 2). The cardholder mobile device 102 and/or cardholder computer system 104 is configured to execute for display on a transaction pre-authentication service application 140. In some embodiments, the transaction pre-authentication service application 140 may be stored in a cloud-based interface, which may include cloud storage capability as well as any cloud-based API that facilitates communication between a merchant client system 130 and the transaction pre-authentication service system 118, and/or between the cardholder devices 102, 104 and the transaction pre-authentication service system 118. The transaction pre-authentication service application 140 stores a user profile associated with the user, for example, in database 14. The user profile includes cardholder contact and financial data for the cardholder 201. Additionally, the user profile may be viewed, accessed, and/or updated by the cardholder mobile device 102 and/or the cardholder computer system 104. The cardholder 201 accesses the transaction pre-authentication service application 140 to communicate with the transaction pre-authentication service system 118, in particular, to pre-authenticate transactions, such as timebound, large, or atypical transactions, using the transaction pre-authentication service system 118.

The pre-authentication system 100 further includes the merchant client system 130, which may include a real or virtual point-of-sale (POS) device, an inventory computing device, or any other computing device capable of communicating with the transaction processor 106 and/or with the transaction pre-authentication service system 118. In the example embodiment, the merchant client system 130 is associated with a merchant 212 (shown in FIG. 2). The transaction pre-authentication service system 118 is configured to access the merchant client system 130 through, for example, a cloud-based interface. The transaction processor 106 and the transaction pre-authentication service system 118 are configured to communicate with merchant client system 130 to receive data (e.g., transaction data, merchant location, etc.) and/or to access any virtual merchant capabilities of the merchant (e.g., to order delivery of an item from the merchant). Additionally or alternatively, at least one of the cardholder mobile device 102 and/or the cardholder computer system 104 may access the merchant client system 130 directly to access the virtual merchant capabilities of the merchant 212. Although only one merchant client system 130 is shown in FIG. 1 for clarity, it is understood that the transaction pre-authentication service system 118 may be coupled in communication with any number of merchant client systems 130.

In the example embodiment, the transaction pre-authentication service system 118 receives transaction pre-authentication data from the cardholder 201 via one or more of the cardholder mobile device 102 and/or the cardholder computer system 104. The transaction pre-authentication data relates to a cardholder’s anticipated future transaction and/or transactions. The transaction pre-authentication data is stored by the transaction pre-authentication service system 118 in the database 14. In addition, the transaction pre-authentication service system 118 receives the cardholder’s real-time transaction data from, for example, the payment network 112. For a given incoming transaction, the transaction pre-authentication service system 118 identifies any cardholder input transaction entries for the cardholder’s account from the transaction pre-authentication data. If there is no transaction pre-authentication data stored for the cardholder’s account, then no further transaction rating processing is performed by the transaction pre-authentication service system 118 and the incoming transaction is processed business-as-usual (BAU) by the payment network 112. If the cardholder’s account has transaction pre-authentication data, the transaction pre-authentication service system 118 matches the incoming transaction data to the cardholder’s transaction pre-authentication data. Based on the matching process, the transaction pre-authentication service system 118 determines that the transaction has been pre-authenticated and transmits authentication data (such as an accountholder authentication value (AAV)) to the payment card issuer 222 for further decisioning.

FIG. 2 is a simplified block diagram of an exemplary payment card network system 200 including the transaction pre-authentication service system 118 for pre-authenticating a transaction to be performed at a subsequent period, in accordance with an aspect of the present disclosure. The payment card network system 200 may be utilized by consumers and merchants as part of a process of pre-authenticating a transaction and subsequently performing the transaction concurrent with delivery of goods or services as described herein via a payment network 242. In addition, the payment card network system 200 is a transaction card account system including a three-domain secure (3DS) client 208 (e.g., the cardholder mobile device 102 and/or the cardholder computer system 104 (shown in FIG. 1)) which a cardholder 201 may use to conduct electronic transactions and/or record payments for electronic transactions related to purchase of a merchant’s goods or services. It should be understood that the various components shown in FIG. 2 may be a subset of a larger system that could be used, for example, to register or enroll the cardholder 201 in the transaction pre-authentication service. It should also be understood that, in some embodiments, cardholders, merchants, issuers, and/or acquirers may participate in the cardholder enrollment or registration process (e.g., via a transaction pre-authentication service website or webpage hosted by a transaction pre-authentication service server computer system). In some aspects, the cardholder enrollment or registration process may occur before transaction pre-authentication processing.

Embodiments described herein may relate to a transaction card system, such as a credit card payment system using the Mastercard^{®} interchange network. (Mastercard is a registered trademark of Mastercard International Incorporated.) The Mastercard interchange network is a set of proprietary communications standards promulgated by Mastercard International Incorporated for the exchange of financial transaction data and the settlement of funds between financial institutions that are members of Mastercard International Incorporated. As used herein, transaction data includes a unique account number associated with an account holder using a payment card issued by an issuer; purchase data representing a purchase made by the cardholder, including a type of merchant, amount of purchase, date of purchase; and/or other data, which may be transmitted between any parties of the payment card network system 200.

In the example embodiment, the system 200 includes a 3DS requestor environment 202, a 3DS authentication and authorization environment 204, and a FIDO server 206. The 3DS requestor environment 202 includes the 3DS client 208 having a digital wallet or pre-authentication application 210, such as the transaction pre-authentication service application 140 (shown in FIG. 1), running thereon. In an embodiment, the pre-authentication application 210 may be the same as the pre-authentication application 140 shown in FIG. 1. The 3DS requestor environment 202 also includes a 3DS requestor 212 (also referred to herein as a merchant) that is implemented on a 3DS server 214. In the example, the 3DS client 208 allows user interface with the 3DS requestor 212. In the example embodiment, the 3DS client 208 is a cardholder device, such as the cardholder mobile device 102 or cardholder computer system 104. The 3DS requestor 212 may be a merchant point-of-sale system that initiates a 3DS authentication request within a transaction process. The 3DS server 214 is a server that handles online transactions and facilitates communication between the 3DS requestor 212 and the authentication and authorization environment 204. The 3DS client 208 communicates with the 3DS requestor 212 via a communication link 215. In some embodiments, the communication link 215 may be 3DS requestor application programming interfaces (APIs), 3DS server APIs, and/or a browser interaction.

The digital wallet/pre-authentication application 210 may be executed to register for a pre-authentication service and/or to pre-authenticate a transaction with the transaction pre-authentication service system 118 (shown in FIG. 1). The digital wallet/pre-authentication application 210 may also communicate with the 3DS requester 212 to initiate the 3DS authentication request within a transaction process. The 3DS server 214 handles online transactions and facilitates communication between the 3DS requester 212 and the 3DS authentication and authorization environment 204.

The cardholder may execute the digital wallet/pre-authentication application 210 to register with the transaction pre-authentication service system 118. During the registration process, to verify the cardholder’s identity, the cardholder provides enrollment data, including financial account details, such as a primary account number (PAN), to the digital wallet/pre-authentication application 210. These details are transmitted to the transaction pre-authentication service system 118 via a communications link 216. A directory server 218, which may be a component of the transaction pre-authentication service system 118, uses the PAN to find an access control server (ACS) 220 associated with the PAN and an issuer 222.

The directory server 218 is communicatively connected to the ACS 220 via a communication link 224. The directory server 218 transmits a 3DS authentication request to the ACS 220 via the communication link 224 to have the cardholder authenticated by the issuer 222.

The issuer 222 authenticates the cardholder in real-time via a communications link 228. For example, and without limitation, the issuer 222 may authenticate the cardholder via a challenge/response 3DS authentication method, such as by a one-time code sent to the cardholder via Short Message Service (SMS), e-mail, through the digital wallet/pre-authentication application 210, through a call center communication, and the like. In the exemplary embodiment, issuer authentication is the preferred method for authenticating the cardholder 201, as the issuer 222 and the cardholder 201 have a direct relationship.

The ACS 220 responds to the directory server 218 via the communication link 224 after authenticating the cardholder associated with the PAN. After receiving the response from the ACS 220, the directory server 218 responds to the digital wallet/pre-authentication application 210 with an authentication response message, confirming to the digital wallet/pre-authentication application 210 that the cardholder is authenticated.

The digital wallet/pre-authentication application 210 initiates contact with the FIDO server 206 via a communication link 226 to enroll in the FIDO authentication system. This typically involves registering a biometric (like fingerprint or face scan) or a security key. For example, when the cardholder has chosen a biometric, such as a fingerprint, as a FIDO authentication method for his or her payment card (i.e., the PAN), the 3DS client 208 generates a public/private key pair associated with the PAN in the digital wallet/pre-authentication application 210 (the application 210 being on the 3DS client 208 and the FIDO server 206). The public key is sent to and stored on the FIDO server 206. The private key, protected by the cardholder’s biometric, remains in the secure memory of the 3DS client 208.

When the cardholder authenticates himself or herself with the biometric via the digital wallet/pre-authentication application 210, and the biometric is correct, the private key associated with the PAN is unlocked. The FIDO authentication request is digitally signed with the private key and sent to the FIDO server 206 where the digital signature is verified using the public key. After the digital signature is verified, the FIDO server 206 returns a response including FIDO attestation data. The FIDO attestation data cryptographically protects the way the transaction pre-authentication service system 118 can verify the data authenticity, integrity, and origin. The 3DS client 208 bundles the FIDO attestation data from the FIDO server 206 with the 3DS data from the 3DS authentication response. The 3DS authentication response received in response to the 3DS authentication request, along with cardholder information, issuer details, card information, etc., as described herein. This information is bound together in the cardholder’s pre-authentication account on the transaction pre-authentication service system 118.

After registering for the transaction pre-authentication service system 118, the cardholder may pre-authenticate a transaction. By pre-authenticating a 3DS transaction with the issuer 222, there is a liability shift from the merchant 212 to the issuer 222 for a fraudulent transaction, such as if the subsequent pre-authenticated 3DS transaction is fraudulent.

In an embodiment, to pre-authenticate a transaction, the cardholder 201 initiates a pre-authentication process in the digital wallet/pre-authentication application 210. For example, the cardholder 201 authenticates on the cardholder device 102 or 104 using the enrolled biometric or other FIDO-enabled method. The digital wallet/pre-authentication application 210 transmits a transaction pre-authentication request, digitally signed by the private key on the 3DS client 208, to the issuer 222 via the communication link 228. The transaction pre-authentication request may include the cardholder’s PAN, a device identifier, cardholder identifying information, etc.

The issuer 222 may transmit the digitally signed request to the transaction pre-authentication service system 118 for validation. The transaction pre-authentication service system 118 validates the request, for example, using a FIDO validation component 230 via a communication link 232. In particular, the transaction pre-authentication service system 118 may include an authentication device 234 configured to verify the authenticity, integrity, and origin of the transaction pre-authentication request data via the FIDO validation component 230. The FIDO component 230 receives the digitally signed transaction pre-authentication request data, verifies the authenticity, integrity, and origin, and transmits back a FIDO authentication response to the transaction pre-authentication service system 118. It is noted that the FIDO component 230 may be a computing system in communication with the FIDO server 206 or may be a component of the FIDO server 206. Accordingly, the FIDO component 230 may access the public key stored on the FIDO server 206, or store a copy of the public key, in order to validate the digitally signed transaction pre-authentication data. The transaction pre-authentication service system 118 may then transmit a response to the issuer 222 validating the request.

The issuer 222 authenticates the cardholder 201 in real-time, via the communications link 228, using a challenge/response 3DS authentication method, as described above. The cardholder 201 inputs transaction pre-authentication data into the digital wallet/pre-authentication application 210 for pre-authenticating the transaction. The transaction pre-authentication data may include, for example, the merchant associated with the pre-authenticated transaction, a duration the pre-authentication is to remain valid, a monetary value or transaction limit for which the pre-authentication is applicable, the authorized device(s) for which the pre-authentication is valid, and the like.

The issuer 222, via the ACS 220, for example, transmits the pre-authenticated transaction information and an indication that the cardholder 201 authentication challenge was successful, to the directory server 218 via the communication link 224. In addition, the ACS 220 may respond to the digital wallet/pre-authentication application 210 with an authentication response message, confirming to the digital wallet/pre-authentication application 210 that the cardholder 201 is authenticated and the transaction is pre-authenticated.

After the transaction pre-authentication service system 118 validates the authenticity, integrity, and origin of the digitally signed transaction pre-authentication request data and the issuer authenticates the cardholder 201 and the transaction, the transaction pre-authentication service system 118 generates a success response that includes an accountholder authentication value (AAV). The AAV binds the cardholder to the specific pre-authenticated transaction. The AAV is transmitted to one or more of the digital wallet/pre-authentication application 210 and the issuer 222.

During a subsequent transaction performed by the cardholder 201 (i.e., a subsequent transaction corresponding to the pre-authenticated transaction), the 3DS server 214 transmits an authentication request to the authentication device 234. In the example, the authentication device 234 and the 3DS server 214 communicate authentication requests and responses via a communication link 236. The 3DS server 214 requests authentication of the cardholder’s payment card (i.e., the PAN) in 3DS by transmitting the authentication request to the authentication device 234. Specifically, the authentication request is a 3DS Authentication Request. The authentication request includes the PAN, a merchant identifier, and transaction data.

The transaction pre-authentication service system 118, via the authentication device 234, matches the PAN, merchant, and transaction data to the pre-authenticated transaction and the associated AAV. The transaction pre-authentication service system 118 appends the AAV to the authentication request. The directory server 218 uses the PAN to identify the ACS 220 and transmits the authentication request to the ACS 220 via the communication link 224. Upon receiving the authentication request with the AAV, the issuer 222 considers the transaction to be fully authenticated. The ACS 220 transmits an authentication request response to the transaction pre-authentication service system 118 authenticating the PAN. Upon receiving the authentication request response from the ACS 220, the transaction pre-authentication service system 118 responds to the 3DS server 214 with the authentication request response message, which includes the AAV and a URL of the ACS 220.

Upon receipt of the authentication request response message, the 3DS server 214 transmits a payment authorization request message to an acquirer 238 via a communication link 240. The payment authorization request message includes the URL of the issuer’s ACS 220 and the AAV. As such, the 3DS server 214 submits the payment authorization message as a fully authenticated transaction. Upon receiving the payment authorization request message from the 3DS server 214, the acquirer 238 transmits an authorization message to the ACS 220 and the issuer 222 via the payment network 242 and the communication links 244 and 246. The ACS 220 and the issuer 222 transmits an authorization request response message, authorizing the payment, back to the acquirer 238. Upon receiving the authorization request response message, the acquirer 238 confirms authorization of the payment authorization request message to the 3DS server 214.

As described herein, the transaction pre-authentication service system 118 is configured to receive, from the cardholder 201, various transaction pre-authentication data and analyze various data associated with the payment card transactions based, in part, on the transaction pre-authentication data. In addition, the transaction pre-authentication service system 118 is configured to provide various information, such as an accountholder authentication value (AAV) to one or more parties involved in the payment card transaction, such as the issuer 222. Specifically, the transaction pre-authentication service system 118 is a specially programmed computer system that enables the payment network 242 to implement, via the transaction pre-authentication service system 118, an automated process for a cardholder to pre-authenticate transactions with the payment network 242.

In the example embodiment, the following associations may be made: one of the client systems 130 may be associated with an acquirer, a user, or a cardholder; another one of the client systems 130 may be associated with an issuer; the cardholder mobile device 102 and the cardholder computer system 104 may be associated with a consumer; and the transaction pre-authentication service system 118 may be associated with a payment network or interchange network. While only one merchant 212, acquirer 238, payment network 242, and issuer 222 are shown in FIG. 2 (for ease of reference), it should be appreciated that a variety of other embodiments may include multiple ones of these parties/components in various combinations.

### EXEMPLARY COMPUTER SYSTEMS

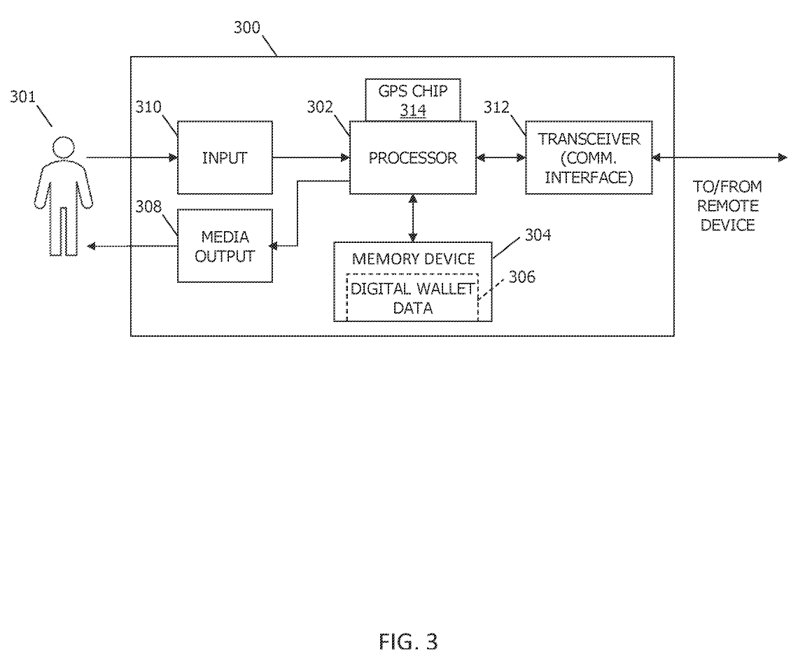

FIG. 3 is an example configuration of a user system 300 used by a user 301, such as the cardholder 201 (shown in FIG. 2). In some embodiments, the user system 300 is a cardholder mobile device 102 (shown in FIG. 1), a cardholder computer system 104 (shown in FIG. 1), and/or a client system 130 (shown in FIG. 1).

In the example embodiment, the user system 300 includes one or more processors 302 for executing instructions. In some embodiments, executable instructions are stored in a memory device 304. The processor 302 may include one or more processing units arranged, for example, in a multi-core configuration. The memory device 304 is any device allowing information such as the digital wallet data 306 (optional), executable instructions, and/or written works to be stored and retrieved. The memory device 304 includes one or more computer readable media.

In one example embodiment, the processor 302 may be implemented as one or more cryptographic processors. A cryptographic processor may include, for example, dedicated circuitry and hardware such as one or more cryptographic arithmetic logic units (not shown) that are optimized to perform computationally intensive cryptographic functions. A cryptographic processor may be a dedicated microprocessor for carrying out cryptographic operations, embedded in a packaging with multiple physical security measures, which facilitate providing a degree of tamper resistance. A cryptographic processor facilitates providing a tamper-proof boot and/or operating environment, and persistent and volatile storage encryption to facilitate secure, encrypted transactions.

A location of the user system 300 can be obtained through conventional methods, such as a location service (e.g., global positioning system (GPS) service) in the user system 300, “ping” data that includes geotemporal data, from cell location register information held by a telecommunications provider to which the user system 300 is connected, and the like. For example, in one suitable embodiment, a GPS chip 314 can be part of or separate from the processor 302 to enable the location of the user system 300 to be determined.

The user system 300 also includes at least one media output component 308 for presenting information to the user 301. The media output component 308 is any component capable of conveying information to the user 301. In some embodiments, the media output component 308 includes an output adapter such as a video adapter and/or an audio adapter. An output adapter is operatively coupled to the processor 302 and operatively connectable to an output device such as a display device, a liquid crystal display (LCD), organic light emitting diode (OLED) display, or “electronic ink” display, or an audio output device, a speaker, or headphones.

In one example embodiment, the media output component 308 includes an integrated display, which can include, for example, and without limitation, a liquid crystal display (LCD), an organic light emitting diode (OLED) display, or an “electronic ink” display. In some embodiments, the integrated display may optionally include a touch controller for support of touch capability. In such embodiments, a cardholder mobile device 102 may detect a person’s presence by detecting that the person has touched the integrated display on the cardholder mobile device 102.

In some embodiments, the user system 300 includes an input device 310 for receiving input from the user 301. The input device 310 may include, for example, a biometric sensor, a touch sensitive panel, a touch pad, a touch screen, a stylus, a gyroscope, an accelerometer, a position detector, a keyboard, a pointing device, a mouse, or an audio input device. A single component such as a touch screen may function as both an output device of the media output component 308 and the input device 310. The user system 300 may also include a transceiver 312 (broadly, a communication interface), which is communicatively connectable to a remote device such as the merchant client system 130 (shown in FIG. 1). The transceiver 312 may include, for example, a wired or wireless network adapter or a wireless data transceiver for use with radio frequency communication, near field communication (NFC), and/or with a mobile phone network, Global System for Mobile communications (GSM), 3G, or other mobile data network, and/or Worldwide Interoperability for Microwave Access (WiMax) and the like.

Stored in the memory device 304 are, for example, computer readable instructions for providing a user interface to the user 301 via the media output component 308 and, optionally, receiving and processing input from the input device 310. A user interface may include, among other possibilities, a web browser and/or the transaction pre-authentication service application 140 (shown in FIG. 1). Web browsers enable users, such as the cardholder 201, to display and interact with media and other information typically embedded on a web page or a website. The web page or website may be associated with the transaction pre-authentication service system 118. The transaction pre-authentication service application 140 allows the cardholder 201 to interact with the transaction pre-authentication service system 118 to pre-register transactions of the cardholder 201.

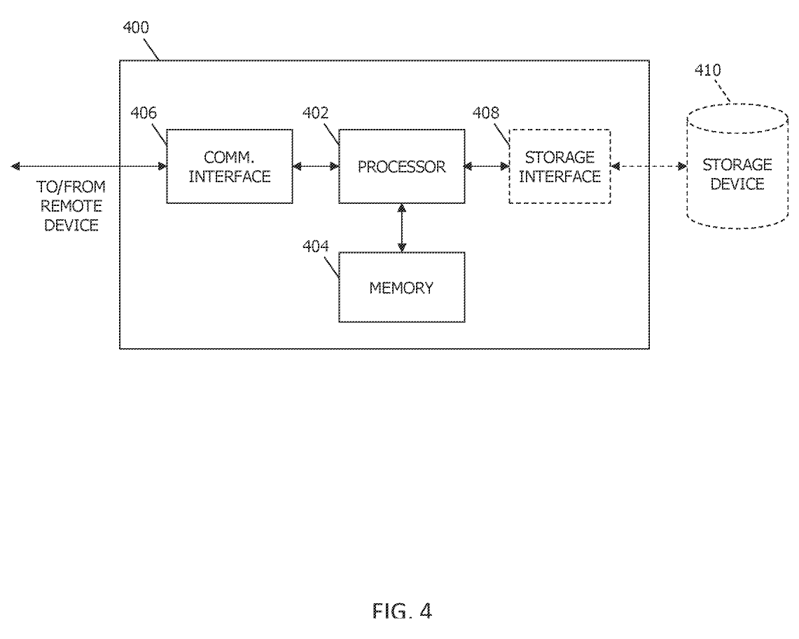

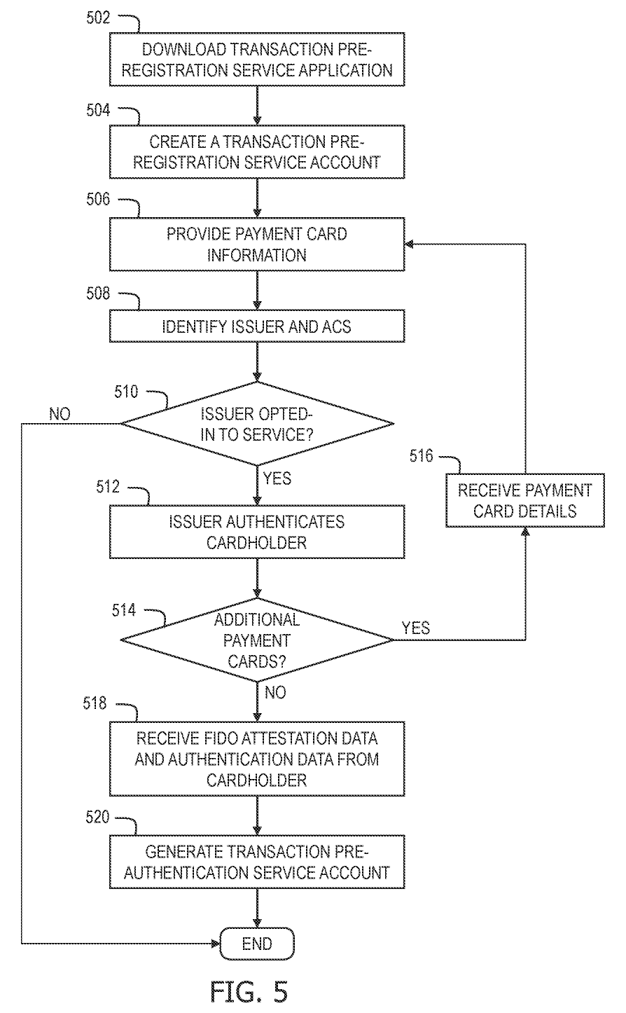

FIG. 4 is an example configuration of a server system 400, such as a FIDO server 206, 3DS server 214, directory server 218, access control server (ACS) 220, and/or FIDO validation component 230 (each shown in FIG. 5). In the example embodiment, the server system 400 includes a processor 402 for executing instructions. The instructions may be stored in a memory area 404, for example. The processor 402 includes one or more processing units (e.g., in a multi-core configuration) for executing the instructions. The instructions may be executed within a variety of different operating systems on the server system 400, such as UNIX, LINUX, Microsoft Windows^{®}, etc. More specifically, the instructions may cause various data manipulations on data stored in a storage device 410 (e.g., create, read, update, and delete procedures). It should also be appreciated that upon initiation of a computer-based method, various instructions may be executed during initialization.

In one example embodiment, the processor 402 may be implemented as one or more cryptographic processors. A cryptographic processor may include, for example, dedicated circuitry and hardware such as one or more cryptographic arithmetic logic units (not shown) that are optimized to perform computationally intensive cryptographic functions. A cryptographic processor may be a dedicated microprocessor for carrying out cryptographic operations, embedded in a packaging with multiple physical security measures, which facilitate providing a degree of tamper resistance. A cryptographic processor facilitates providing a tamper-proof boot and/or operating environment, and persistent and volatile storage encryption to facilitate secure, encrypted transactions.

The processor 402 is operatively coupled to a communication interface 406 such that the server system 400 can communicate with a remote device such as a user system 300 or another server system. For example, the communication interface 406 may receive communications from the cardholder mobile device 102 and/or the cardholder computer system 104 via the Internet, as illustrated in FIG. 1.

The processor 402 is operatively coupled to the storage device 410. The storage device 410 is any computer-operated hardware suitable for storing and/or retrieving data. In some embodiments, the storage device 410 is integrated in the server system 400 and is like the database 14 (shown in FIG. 1). In other embodiments, the storage device 410 is external to the server system 400 and is like the transaction database 134 (shown in FIG. 2). For example, the server system 400 may include one or more hard disk drives as the storage device 410. In other embodiments, the storage device 410 is external to the server system 400 and may be accessed by a plurality of server systems 400. For example, the storage device 410 may include multiple storage units such as hard disks or solid-state disks in a redundant array of inexpensive disks (RAID) configuration. The storage device 410 may include a storage area network (SAN) and/or a network attached storage (NAS) system.

In some embodiments, the processor 402 is operatively coupled to the storage device 410 via a storage interface 408. The storage interface 408 is any component capable of providing the processor 402 with access to the storage device 410. The storage interface 408 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 402 with access to the storage device 410.

The memory area 404 includes, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer program.

### COMPUTER-IMPLEMENTED METHODS

FIG. 5 is a flowchart illustrating an exemplary computer-implemented method 500 for registering a cardholder for a transaction pre-authentication service, in accordance with one embodiment of the present disclosure. The operations described herein may be performed in the order shown in FIG. 5 or may be performed in a different order. Furthermore, some operations may be performed concurrently as opposed to sequentially. In addition, some operations may be optional.

The computer-implemented method 500 is described below, for ease of reference, as being executed by exemplary devices and components introduced with the embodiments illustrated in FIGS. 1–4. In one embodiment, the method 500 may be implemented by the transaction pre-authentication service system 118 (shown in FIGS. 1 and 2). In the exemplary embodiment, the method 500 relates to receiving cardholder registration information from the cardholder mobile device 102 (shown in FIG. 1) upon registration for the transaction pre-authentication service. While operations within the method 500 are described below regarding the cardholder mobile device 102, the method 500 may be implemented on the cardholder computer system 104 as well as other computing devices and/or systems through the utilization of processors, transceivers, hardware, software, firmware, or combinations thereof. However, a person having ordinary skill will appreciate that responsibility for all or some of such actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the steps outlined herein. The program(s) stored on the computer-readable medium(s) may instruct the processor or processing units to perform additional, fewer, or alternative actions, including those discussed elsewhere herein.

Referring to operation 502, in the example embodiment, the cardholder 201 downloads the transaction pre-authentication service application 140 (shown in FIG. 1). For example, the cardholder 201 may connect to the transaction pre-authentication service system 118, which may instruct the cardholder 201 to download the transaction pre-authentication service application 140 to the cardholder mobile device 102 for direct communication with the transaction pre-authentication service system 118 via the payment network 112, e.g., without use of a web browser. When the cardholder 201 uses the transaction pre-authentication service application 140, a direct link is established via a wireless connection, for example, via a Wi-Fi connection to the Internet.

Referring to operation 502, the cardholder 201 downloads the transaction pre-authentication service application 140. The cardholder mobile device 102, such as a web-based smartphone, is configured to execute for display the transaction pre-authentication service application 140. In some embodiments, the transaction pre-authentication service application 140 may be stored in a cloud-based interface, which may include cloud storage capability as well as any cloud-based API that facilitates communication between the cardholder mobile device 102 and transaction pre-authentication service system 118. The transaction pre-authentication service application 140 facilitates transmitting and receiving data between the cardholder mobile device 102 and transaction pre-authentication service system 118 for enrolling the cardholder and pre-registering anticipated transactions.

At operation 504, the cardholder 201 is presented an option to create a transaction pre-authentication service account. For example, the cardholder 201 enrolls for the transaction pre-authentication service via the transaction pre-authentication service application 140 or via a suitable webpage of the transaction pre-authentication service system 118 using, for example, the cardholder computer system 104. It should be understood that the cardholder 201 may enroll or register with the transaction pre-authentication service in any of several ways, including utilizing the cardholder computer system 104 to access the transaction pre-authentication service system 118 via the Internet and provide required information.

During cardholder enrollment, the cardholder 201 may provide enrollment data including basic information about himself or herself (e.g., name, address, phone number, etc.) and, in some embodiments, provide information regarding the cardholder’s mobile devices (for example, by providing a hardware identifier such as a SIM identifier and/or a mobile telephone number and/or other device identifier). In addition, the cardholder 201 may provide information and/or preferences concerning one or more family members, such as a spouse and/or children to form a “Household” transaction pre-authentication service account. It is noted that the transaction pre-authentication service account can be linked to other Mastercard services if the cardholder 201 is already signed up for other unrelated services. In some embodiments, the information obtained from the cardholder 201 during the enrollment process includes product and/or service preferences, and/or other information.

At operation 506, the cardholder 201 may also provide information concerning his or her payment card, e.g., a bank credit card account, a debit card account, a loyalty card account, and/or a gift card issued to or held by him or her. The information may include, for example, a primary account number (PAN).

At operation 508, the transaction pre-authentication service system 118 may use the PAN to find the issuer, such as the issuer 222 (shown in FIG. 2), of the payment account/card and to identify the access control server (ACS), such as the ACS 220 (shown in FIG. 2) associated with the issuer 222.

At operation 510, the transaction pre-authentication service system 118 determines whether the issuer 222 of the payment card has opted-in to the transaction pre-authentication service. If the issuer 222 chooses to opt-in to the transaction pre-authentication service, at operation 512 the issuer 222 authenticates the cardholder 201 in real-time. For example, and without limitation, the transaction pre-authentication service system 118 may transmit a 3DS authentication request to the ACS 220. In response to the request, the issuer 222 may authenticate the cardholder 201 via a one-time code sent to the cardholder 201 via Short Message Service (SMS), e-mail, through an issuer mobile application, through a call center communication, and the like, as the issuer 222 and the cardholder 201 have a direct relationship. If the issuer 222 is not opted-in to the transaction pre-authentication service and therefore, does not participate in the enrollment process, the method 500 ends.

At operation 514, the transaction pre-authentication service system 118 asks the cardholder 201 whether the cardholder has additional payment cards he or she wishes to associate with the cardholder’s transaction pre-authentication service account. If the cardholder has additional payment cards to enter, at operation 516, the transaction pre-authentication service system 118 receives the payment card details from the cardholder 201 and returns to operation 506. If the cardholder does not have any additional payment cards to enter, the method continues to operation 518.

At operation 518, the transaction pre-authentication service system 118 receives FIDO attestation data and 3DS data from the 3DS authentication response received in response to the 3DS authentication request. This information is bound together in the cardholder’s pre-authentication account on the transaction pre-authentication service system 118. As part of the registration process, the cardholder 201 registers a biometric with a FIDO authentication system, as described herein. The FIDO attestation data is transmitted to and used by the transaction pre-authentication service system 118 to authenticate messages received from the cardholder 201 via the cardholder devices 102 or 104.

At operation 520, the transaction pre-authentication service system 118 generates the transaction pre-authentication service account for the cardholder 201, associating (i.e., binding) the cardholder’s one or more payment cards with the account, along with the cardholder’s FIDO attestation data, issuer details, and cardholder information.

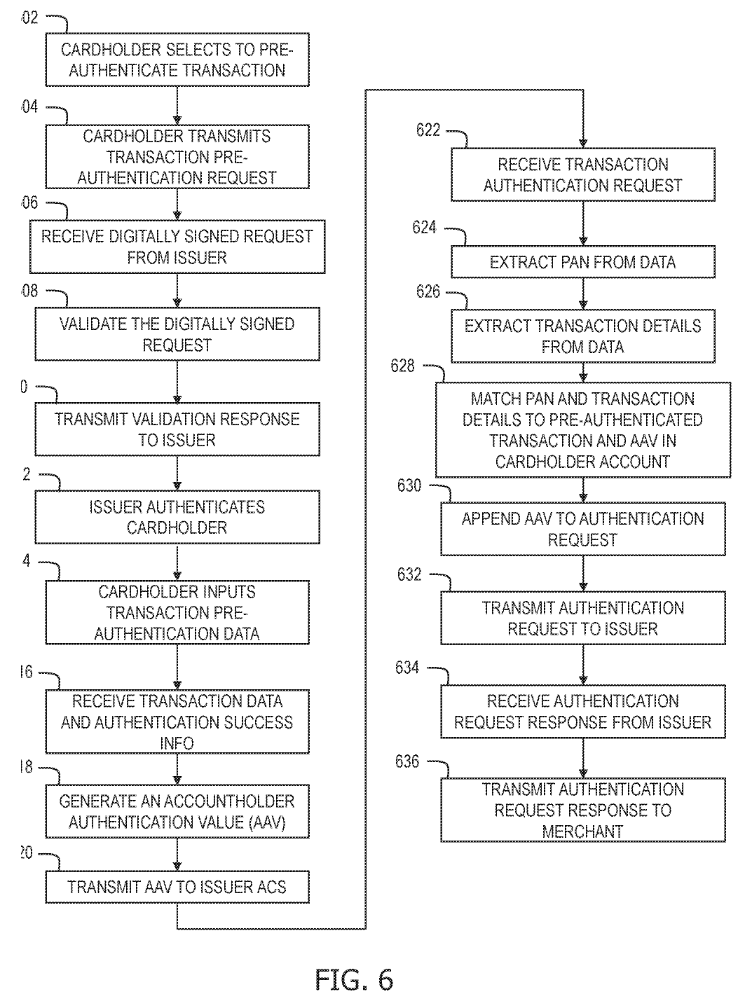

FIG. 6 is a flowchart illustrating a computer-implemented method 600 for pre-authenticating a transaction using a transaction pre-authentication service, in accordance with one embodiment of the present disclosure. The operations described herein may be performed in the order shown in FIG. 6 or may be performed in a different order. Furthermore, some operations may be performed concurrently as opposed to sequentially. In addition, some operations may be optional.

The computer-implemented method 600 is described below, for ease of reference, as being executed by exemplary devices and components introduced with the embodiments illustrated in FIGS. 1–4. In one embodiment, the method 600 may be implemented by the transaction pre-authentication service system 118 (shown in FIGS. 1 and 2). In the exemplary embodiment, the method 600 relates to the operations of receiving transaction pre-authentication data from the cardholder 201 (shown in FIG. 1) and corresponding transaction data from a merchant, such as the 3DS requester 212 (also referred to herein as a merchant, shown in FIG. 2). While operations within the method 600 are described below regarding the cardholder mobile device 102, the method 600 may be implemented on the cardholder computer system 104 as well as other devices and/or systems through the utilization of processors, transceivers, hardware, software, firmware, or combinations thereof. However, a person having ordinary skill will appreciate that responsibility for all or some of such actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the steps outlined herein. The program(s) stored on the computer-readable medium(s) may instruct the processor or processing units to perform additional, fewer, or alternative actions, including those discussed elsewhere herein.

At operation 602, in the example embodiment, the cardholder 201 decides that he or she wishes to pre-authenticate a purchase transaction. For example, and without limitation, the cardholder 201 may decide that he or she will perform a large and/or atypical purchase transaction, or a transaction that may be timebound, in the near future. For example, in one embodiment, the cardholder 201 may wish to purchase a television at the merchant 212. The television may have a price of about $2,000.00, which is a large and/or atypical purchase for the cardholder 201 based on the cardholder’s transaction history. In another embodiment, the cardholder 201 may wish to perform a timebound transaction, such as a transaction to purchase tickets to an event, in which the cardholder 201 must checkout and complete the transaction within a specified time period.

At operation 604, the cardholder 201 transmits a transition pre-authentication request, digitally signed by the private key on the 3DS client 208, to the issuer 222. The transaction pre-authentication request may include the cardholder’s PAN, a device identifier, cardholder identifying information, etc. At operation 606, the issuer 222 transmits the digitally signed request to the transaction pre-authentication service system 118 for validation.

At operation 608, the transaction pre-authentication service system 118 validates the request, for example, using the FIDO validation component 230. For example, the transaction pre-authentication service system 118 transmits the digitally signed transaction pre-authentication request data to the FIDO component 230. The FIDO component 230 verifies the authenticity, integrity, and origin of the data by using the public key associated with the private key used to digitally sign the transaction pre-authentication request data. The FIDO component 230 transmits back a FIDO authentication response to the transaction pre-authentication service system 118. At operation 610, the transaction pre-authentication service system 118 transmits a response to the issuer 222 validating the transaction pre-authentication request data.

At operation 612, the issuer 222 authenticates the cardholder 201 in real-time using a challenge/response 3DS authentication method, as described above. Upon being authenticated by the issuer 222, the cardholder 201 inputs transaction pre-authentication data into the digital wallet/pre-authentication application 210 for pre-authenticating the transaction, at operation 614. For example, and without limitation, the transaction pre-authentication service system 118 may present a transaction data input wizard to the cardholder 201 for inputting the transaction pre-authentication data. Moreover, the transaction pre-authentication service system 118 may store the transaction pre-authentication data in memory, such as memory 404 (shown in FIG. 4) or the storage device 410 (shown in FIG. 4). The transaction pre-authentication data may correspond to a payment card associated with the cardholder’s transaction pre-authentication service account.

The transaction pre-authentication data input by the cardholder 201 may include, for example, a merchant name associated with the pre-authenticated transaction, a merchant category code, a duration the pre-authentication is to remain valid, a transaction amount and/or transaction amount limit for which the pre-authentication is applicable, the authorized device(s) for which the pre-authentication is valid, and the like.

In an embodiment, the duration includes the specific time-period for which the pre-authenticated biometric authentication of the cardholder remains valid. For example, the cardholder’s biometric identity may be pre-authenticated for a duration of twenty-four (24) hours, allowing pre-authenticated transactions during this period without the need for additional authentication.

In an embodiment, the amount or transaction limit includes the monetary value or monetary value limit for which the pre-authenticated biometric identity is applicable. For example, the pre-authenticated biometric identity can be leveraged for transactions below a value of one thousand dollars ($1,000), one hundred dollars ($100), etc. ensuring a seamless experience without compromising security.

In an embodiment, authorized device(s) include the cardholder devices, such as devices 102 and 104, for which the pre-authenticated identity can be leveraged; that is, the cardholder devices linked to the cardholder’s transaction pre-authentication service account. For example, a cardholder may register his or her smartphone and smartwatch as authorized devices, enabling pre-authenticated biometric identity for transactions initiated from only these devices while requiring additional authentication for transactions from other, un-registered devices. It is noted that the transaction pre-authentication data submitted by the cardholder 201 may include more or less data than described herein.

At operation 616, the issuer 222 transmits the pre-authenticated transaction information and an indication that the authentication challenge of cardholder 201 was successful to the directory server 218. In addition, in some embodiments, the ACS 220 may respond to the digital wallet/pre-authentication application 210 with an authentication response message, confirming to the digital wallet/pre-authentication application 210 that the cardholder 201 was successfully authenticated and that the transaction is pre-authenticated. In an example, the issuer 222 may consider various factors and/or parameters when deciding whether to pre-authenticate the transaction. For instance, in an embodiment, the issuer 222 may consider various risk parameters. Risk parameters include parameters defining a level of risk deemed acceptable for transactions without subsequent authentication. Risk parameters may include factors such as transaction frequency, geographical location, unusual spending patterns, and/or other industry acceptable factors. For example, transactions originating from a foreign location or transactions exceeding a certain frequency within a defined period may trigger additional authentication to mitigate potential risks. In these instances, the issuer 222 may decline to pre-authenticate the transaction.

Similarly, the issuer 222 may consider various contextual parameters. Contextual parameters include any additional parameters that take into consideration the context of the transaction, which server to enhance security. For example, such contextual parameters may include time of day, user behavior patterns, or transaction history, which can further refine the authentication process. For instance, a transaction initiated during the cardholder’s typical shopping hours, based on transaction history, may be subject to fewer authentication requirements.

Another consideration by the issuer 222 may include the transaction type. For example, the issuer 222 may apply differentiating parameters based on the type of transaction being conducted. For example, the pre-authenticated identity of the cardholder 201 may be applicable for low-risk transactions, like checking an account balance or making small purchases, while high-risk transactions, such as fund transfers above a certain threshold, may always require additional authentication.

At operation 618, after the transaction pre-authentication service system 118 validates the authenticity, integrity, and origin of the digitally signed transaction pre-authentication request data and the issuer 222 completes its authentication steps, the transaction pre-authentication service system 118 generates an accountholder authentication value (AAV), without the need to prompt the cardholder 201 to authenticate. The AAV binds the cardholder 201 to the specific pre-authenticated transaction. At operation 620, the AAV is transmitted to the issuer 222, and more particularly, to the ACS 220.

At operation 622, the transaction pre-authentication service system 118 receives a 3DS authentication request, which includes the PAN, a merchant identifier, and transaction data, from the merchant 212. At operation 624, the transaction pre-authentication service system 118 may extract the PAN from the 3DS authentication request. Specifically, the transaction pre-authentication service system 118 may extract a copy of the PAN from the 3DS authentication request and temporarily store it in memory, such as memory 404 (shown in FIG. 4). In addition, at operation 626, the transaction pre-authentication service system 118 may extract the transaction details from the 3DS authentication request, including, for example, the transaction amount, the transaction date and time, the merchant, the type of transaction (e.g., whether a card present or card-not-present transaction), and the like.

At operation 628, the transaction pre-authentication service system 118 may then match the PAN to the payment card associated with the cardholder’s transaction pre-authentication service account, as well as match the transaction details to the pre-authenticated transaction and the associated AAV.

Upon a match, the transaction pre-authentication service system 118 appends the AAV to the authentication request, at operation 630, and transmits the request to the issuer 222, at operation 632. For example, the directory server 218 uses the PAN to identify the ACS 220 and transmits the authentication request to the ACS 220. Upon receiving the authentication request with the AAV, the issuer 222 considers the transaction to be fully authenticated.

At operation 634, the issuer 222, via the ACS 220, transmits an authentication request response to the transaction pre-authentication service system 118 authenticating the PAN. Upon receiving the authentication request response from the ACS 220, at operation 636, the transaction pre-authentication service system 118 responds to the merchant 212 with the authentication request response message, which includes the AAV and a URL of the ACS 220. The merchant 212 then processes the transaction BAU, as described above with respect to FIG. 2.

It is noted that, while the issuer 222 may consider the pre-authenticated transaction to be fully authenticated, as discussed at operation 632, the issuer 222 may still choose to decline the transaction, as the issuer 222 ultimately determines whether to approve or decline the pre-authenticated transaction at the time of the transaction. However, the issuer 222 will always receive the authentication request with the appended AAV from the transaction pre-authentication service system 118 for each pre-authenticated transaction.

Any actions, functions, operations, and the like recited herein may be performed in the order shown in the figures and/or described above or may be performed in a different order. Furthermore, some operations may be performed concurrently as opposed to sequentially. Although the methods are described above, for the purpose of illustration, as being executed by an example system and/or example physical elements, it will be understood that the performance of any one or more of such actions may be differently distributed without departing from the spirit of the present invention.

### ADDITIONAL CONSIDERATIONS

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

The detailed description is to be construed as exemplary only and does not describe every possible embodiment because describing every possible embodiment would be impractical. Numerous alternative embodiments may be implemented, using either current technology or technology developed after the filing date of this application, which would still fall within the scope of the invention.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order recited or illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The foregoing statements in this paragraph shall apply unless so stated in the description and/or except as will be readily apparent to those skilled in the art from the description.

As used herein, the term “database” includes either a body of data, a relational database management system (RDBMS), or both. As used herein, a database includes, for example, and without limitation, a collection of data including hierarchical databases, relational databases, flat file databases, object-relational databases, object-oriented databases, and any other structured collection of records or data that is stored in a computer system. Examples of RDBMS’s include, for example, and without limitation, Oracle® Database (Oracle is a registered trademark of Oracle Corporation, Redwood Shores, Calif.), MySQL, IBM® DB2 (IBM is a registered trademark of International Business Machines Corporation, Armonk, N.Y.), Microsoft® SQL Server (Microsoft is a registered trademark of Microsoft Corporation, Redmond, Wash.), Sybase® (Sybase is a registered trademark of Sybase, Dublin, Calif.), and PostgreSQL® (PostgreSQL is a registered trademark of PostgreSQL Community Association of Canada, Toronto, Canada). However, any database may be used that enables the systems and methods to operate as described herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processor, may be implemented as special purpose or as general purpose. For example, the processor may comprise dedicated circuitry or logic that is permanently configured, such as an application-specific integrated circuit (ASIC), or indefinitely configured, such as a field-programmable gate array (FPGA), to perform certain operations. The processor may also comprise programmable logic or circuitry (e.g., as encompassed within a general-purpose processor or other programmable processor) that is temporarily configured by software to perform certain operations. It will be appreciated that the decision to implement the processor as special purpose, in dedicated and permanently configured circuitry, or as general purpose (e.g., configured by software) may be driven by cost and time considerations.

Accordingly, the term “processor” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processor is temporarily configured (e.g., programmed), each of the processors need not be configured or instantiated at any one instance in time. For example, where the processor includes a general-purpose processor configured using software, the general-purpose processor may be configured as respective different processors at different times. Software may accordingly configure the processor to constitute a particular hardware configuration at one instance of time and to constitute a different hardware configuration at a different instance of time.

Computer hardware components, such as transceiver elements, memory elements, processors, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processors may be located in a single location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processor and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the disclosure has been described with reference to the embodiments illustrated in the attached figures, it is noted that equivalents may be employed, and substitutions made herein, without departing from the scope of the disclosure as recited in the claims.

Having thus described various embodiments of the disclosure, what is claimed as new and desired to be protected by Letters Patent includes the following:

1. A computer-implemented method comprising operations of:
receiving a digitally signed pre-authentication request from a cardholder device;
validating the digitally signed pre-authentication request;
receiving pre-authentication data from the cardholder device, the pre-authentication data including a primary account number and being associated with a pre-authenticated transaction;
receiving, from an issuer associated with the cardholder device, authentication success information indicating authentication of the cardholder;
generating an accountholder authentication value (AAV) for the pre-authenticated transaction;
transmitting the AAV to the issuer;
receiving a transaction authentication request message including cardholder transaction data from a merchant device, the transaction authentication request message being associated with the pre-authenticated transaction;
extracting transaction details from the received cardholder transaction data;
matching the extracted transaction details to the received pre-authentication data;
based on the matching, generating a modified transaction authentication request message by appending the AAV to the transaction authentication request message; and
transmitting the modified transaction authentication request message to the issuer.

2. The computer-implemented method in accordance with claim 1, further comprising:
receiving, from the issuer, an authentication response authenticating the pre-authenticated transaction based on the AAV appended to the modified transaction authentication request message.

3. The computer-implemented method in accordance with claim 1, wherein validating the digitally signed pre-authentication request comprises:
transmitting the digitally signed pre-authentication request to a fast identity online (FIDO) component;
verifying a digital signature of the digitally signed pre-authentication request using a public key corresponding the digital signature; and
receiving, from the FIDO component, a FIDO authentication response.

4. The computer-implemented method in accordance with claim 1, wherein receiving the pre-authentication data from the cardholder device comprises presenting a data input wizard to the cardholder for inputting the pre-authentication data.

5. The computer-implemented method in accordance with claim 1, wherein receiving the pre-authentication data from the cardholder device comprises receiving transaction pre-authentication data associated with a selected payment card of the cardholder.

6. The computer-implemented method in accordance with claim 5, wherein receiving the transaction authentication request message including the cardholder transaction data from the merchant device comprises receiving cardholder transaction data associated with the selected payment card of the cardholder.

7. The computer-implemented method in accordance with claim 1, wherein the transaction authentication request message includes a second primary account number.

8. The computer-implemented method in accordance with claim 7, wherein extracting the transaction details from the received cardholder transaction data comprises:
extracting a copy of the second primary account number; and
temporarily storing the extracted copy of the primary account number in a memory device.

9. The computer-implemented method in accordance with claim 8, further comprising:
matching the extracted copy of the second primary account number to the primary account number of the pre-authentication data.

10. The computer-implemented method in accordance with claim 1, wherein receiving the pre-authentication data from the cardholder comprises receiving one or more of the following: a transaction amount, a transaction amount limit, a merchant name, a merchant category code, a duration, and an authorized device.

11. The computer-implemented method in accordance with claim 1, further comprising generating a transaction pre-authentication service account for the cardholder, comprising:
presenting to the cardholder an option to create a transaction pre-authentication service account;
receiving, from the cardholder, enrollment data including the primary account number, the primary account number being associated with a payment account of the cardholder;
storing the primary account number; and
authenticating the cardholder.

12. A system comprising:
one or more processors; and
a memory storing computer-executable instructions thereon, the computer-executable instructions, when executed by the one or more processors, causing the one or more processors to perform operations of:
receiving a digitally signed pre-authentication request from a cardholder device;
validating the digitally signed pre-authentication request;
receiving pre-authentication data from the cardholder device, the pre-authentication data including a primary account number and being associated with a pre-authenticated transaction;
receiving, from an issuer associated with the cardholder device, authentication success information indicating authentication of the cardholder;
generating an accountholder authentication value (AAV) for the pre-authenticated transaction;
transmitting the AAV to the issuer;
receiving a transaction authentication request message including cardholder transaction data from a merchant device, the transaction authentication request message being associated with the pre-authenticated transaction;
extracting transaction details from the received cardholder transaction data;
matching the extracted transaction details to the received pre-authentication data;
based on the matching, generating a modified transaction authentication request message by appending the AAV to the transaction authentication request message; and
transmitting the modified transaction authentication request message to the issuer.

13. The system in accordance with claim 12,
the computer-executable instructions further causing the one or more processors to perform an operation of receiving, from the issuer, an authentication response authenticating the pre-authenticated transaction based on the AAV appended to the modified transaction authentication request message.

14. The system in accordance with claim 12,
the operation of validating the digitally signed pre-authentication request includes:
transmitting the digitally signed pre-authentication request to a fast identity online (FIDO) component;
verifying a digital signature of the digitally signed pre-authentication request using a public key corresponding the digital signature; and
receiving, from the FIDO component, a FIDO authentication response.

15. The system in accordance with claim 12,
the operation of receiving the pre-authentication data from the cardholder device comprises presenting a data input wizard to the cardholder for inputting the pre-authentication data.

16. The system in accordance with claim 12,
the operation of receiving the pre-authentication data from the cardholder device comprises receiving transaction pre-authentication data associated with a selected payment card of the cardholder.

17. The system in accordance with claim 16,
the operation of receiving the transaction authentication request message including the cardholder transaction data from the merchant device comprises receiving cardholder transaction data associated with the selected payment card of the cardholder.

18. The system in accordance with claim 12, wherein the transaction authentication request message includes a second primary account number.

19. The system in accordance with claim 18,
the operation of extracting the transaction details from the received cardholder transaction data comprises:
extracting a copy of the second primary account number; and
temporarily storing the extracted copy of the second primary account number in a memory device.

20. The system in accordance with claim 19,
the computer-executable instructions further causing the one or more processors to perform an operation matching the extracted copy of the second primary account number to the primary account number of the pre-authentication data.
